(19) United States
(12) Patent Application Publication
(10) Pub. No.: US 2026/0220522 A1
(43) Pub. Date: Jul. 30, 2026

(54) MACHINE LEARNING MODEL MANAGER

(71) Applicant: PagerDuty, Inc., San Francisco, CA (US)

(72) Inventor: Manudath Gurudatha, San Francisco, CA (US)

(21) Appl. No.: 19/038,028

(22) Filed: Jan. 27, 2025

(51) Int. Cl. G06N 20/00

(52) U.S. Cl. CPC G06N 20/00

(57) ABSTRACT

Techniques are described for a system configured to obtain, from a customer system, a set of features that define a customer use case for a software service, wherein the software service is offered by the customer system, and wherein operation of the software service is monitored by the operations management system; select, based on the set of features, a machine learning model from a plurality of machine learning models; configure, based on selecting the machine learning model, an instance of the machine learning model to perform the customer use case; detect event data associated with the software service; determine, by at least applying the instance of the machine learning model to the event data, a disruption to the software service; and output an indication of the disruption.

### TECHNICAL FIELD

This disclosure relates generally to managing machine learning models.

### BACKGROUND

Machine learning models are increasingly being implemented for Artificial Intelligence (AI) services offered by various organizations. Organization systems may include a collection of hardware and software modules configured to execute machine learning models to provide AI services. In some examples, organization systems may provide AI services using hardware and software modules configured to communicate with an external machine learning system hosting execution of machine learning models.

### SUMMARY

Aspects of the present disclosure describe techniques for managing a machine learning model for performing a particular customer use case. Machine learning model management, such as selecting a machine learning model or diagnosing issues associated with machine learning model functionality, may include a nondeterministic technical problem of detecting regressions associated with machine learning models, such as changes to source code associated with the machine learning models. An operations management system, according to the techniques described herein, may be configured to manage machine learning model operations across multiple customer systems to automatically detect and analyze regressions associated with machine learning models for managing machine learning model implementations to have consistent quality of performance for the customer systems.

An operations management system may retrieve a set of features defining a customer use case for a software service offered by a customer system. For example, the operations management system may retrieve a set of features indicating quality, performance, security, compliance or other criteria, parameters, or thresholds associated with a customer use case (e.g., classification, prediction, or generative tasks) for a software service (e.g., medical services, educational services, data management services, etc.). The operations management system may select a machine learning model from a repository of machine learning models based on the set of features. For instance, the operations management system may select the machine learning model based on determining that the machine learning model corresponds to the set of features (e.g., satisfies criteria, parameters, or thresholds associated with a customer use case defined by a set of features). The operations management system may configure an instance of the selected machine learning model to perform the customer use case.

The operations management system may detect event data associated with a software service associated with implementation of an instance of a machine learning model. The operations management system may determine, based on the event data, a disruption to the software service to manage implementation of the instance of the machine learning model. For example, the operations management system may apply an instance of a selected machine learning model to event data to classify or categorize at least a portion of the event data as a disruption (e.g., violations associated with feature thresholds of an inference latency, throughput, memory utilization, processing efficiency, computing constraints, etc.) to the software service. In some examples, the operations management system may diagnose whether configurations associated with the instance of the selected machine learning model may be a potential cause of the disruption by comparing the event data to metrics associated with the instance of the machine learning model.

In one example, a system comprises one or more processors having access to a memory. The one or more processors may be configured to obtain, from a customer system, a set of features that define a customer use case for a software service, wherein the software service is offered by the customer system, and wherein operation of the software service is monitored by the operations management system; select, based on the set of features, a machine learning model from a plurality of machine learning models; configure, based on selecting the machine learning model, an instance of the machine learning model to perform the customer use case; detect event data associated with the software service; determine, by at least applying the instance of the machine learning model to the event data, a disruption to the software service; and output an indication of the disruption.

In another example, a method may include obtaining, by an operations management system and from a customer system, a set of features that define a customer use case for a software service, wherein the software service is offered by the customer system, and wherein operation of the software service is monitored by the operations management system; selecting, by the operations management system and based on the set of features, a machine learning model from a plurality of machine learning models; configuring, by the operations management system and based on selecting the machine learning model, an instance of the machine learning model to perform the customer use case; detecting, by the operations management system, event data associated with the software service; determining, by the operations management system and by at least applying the instance of the machine learning model to the event data, a disruption to the software service; and outputting, by the operations management system, an indication of the disruption.

In yet another example, a computer-readable storage medium encoded with instructions that, when executed, causes at least one processor of a computing device to generate machine learning model metadata for the plurality of machine learning models based on a plurality of feedback signals indicating performance data associated with applying the plurality of machine learning models across a plurality of customer systems; determine, based on the plurality of feedback signals and a plurality of features including the set of features, feature values for each of the plurality of machine learning models; update the machine learning model metadata to include feature values for each of the plurality of machine learning models; for each machine learning model of the plurality of machine learning models, determine a score based on the machine learning model metadata and the set of features; and select the machine learning model based on the score.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF THE DRAWINGS

FIG. 1 is a block diagram illustrating an example system for managing example machine learning models for example customer systems, in accordance with the techniques of this disclosure.

FIG. 2 is a block diagram illustrating an example operations management system for selecting, configuring, and otherwise managing machine learning models, in accordance with one or more techniques of this disclosure.

FIG. 3 is a conceptual diagram illustrating an example user interface for use case feature settings, in accordance with techniques of this disclosure.

FIG. 4 is a conceptual diagram illustrating an example user interface for customer agent settings for collecting example feedback signals, in accordance with techniques of this disclosure.

FIG. 5 is a conceptual diagram illustrating example machine learning model metadata, in accordance with techniques of this disclosure.

FIG. 6 is a conceptual diagram illustrating an example user interface indicating performance associated with a machine learning model implementation, in accordance with techniques of this disclosure.

FIG. 7 is a flow chart illustrating an example process of managing machine learning models applied to customer use cases for software services, in accordance with one or more aspects of the present disclosure.

Like reference characters denote like elements throughout the text and figures.

### DETAILED DESCRIPTION

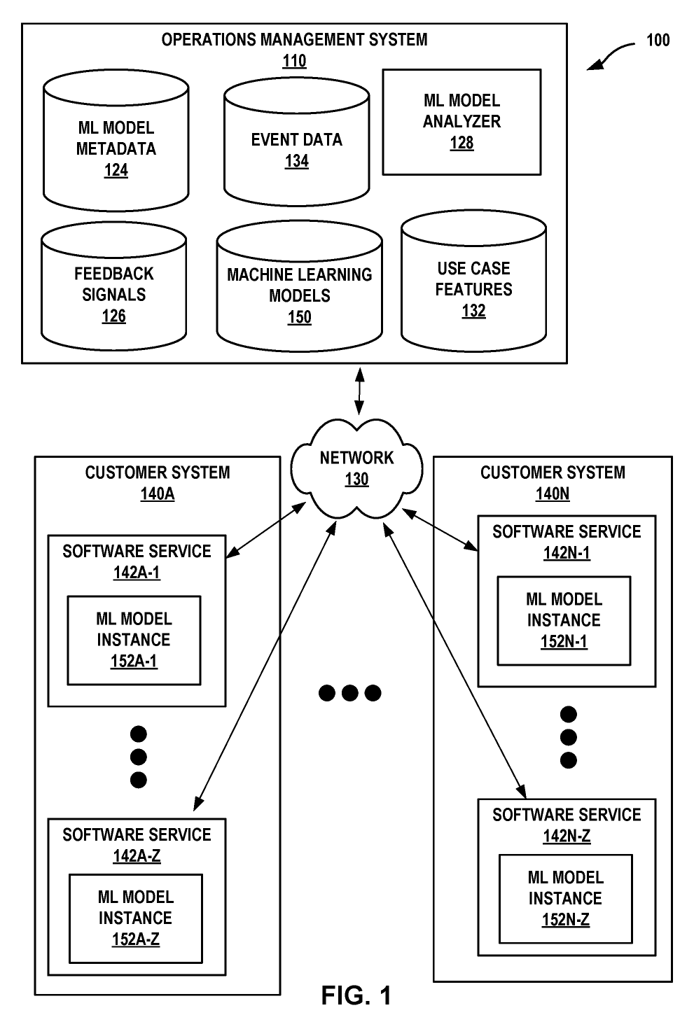

FIG. 1 is a block diagram illustrating example system 100 for managing example machine learning models 150A-1–150N-Z for example customer systems 140A–140N, in accordance with the techniques of this disclosure. In the example of FIG. 1, system 100 may include operations management system 110, customer systems 140A–140N (collectively referred to herein as “customer systems 140”), and network 130.

Network 130 may include any public or private communication network, such as a cellular network, Wi-Fi network, or other type of network for transmitting data between computing devices. In some examples, network 130 may represent one or more packet switched networks, such as the Internet. Operations management system 110 and machine learning models 150A-1–150N-Z (collectively referred to herein as “machine learning models 150”) of customer systems 140, for example, may send and receive data across network 130 using any suitable communication techniques. For example, operations management system 110 and machine learning models 150 may be operatively coupled to network 130 using respective network links. Network 130 may include network hubs, network switches, network routers, terrestrial and/or satellite cellular networks, etc., that are operatively inter-coupled thereby providing for the exchange of information between operations management system 110, machine learning models 150, and/or another computing device or computing system. In some examples, network links of network 130 may include Ethernet, ATM or other network connections. Such connections may include wireless and/or wired connections.

Customer systems 140 may represent a cloud computing system that provides one or more services via network 130. Customer systems 140 may include a collection of hardware devices, software components, and/or data stores that can be used to implement one or more applications or services related to business operations of respective clients or customers utilizing features provided by operations management system 110. Customer systems 140 may represent a cloud-based implementation. In some examples customer systems 140 may include, but are not limited to, portable, mobile, or other devices, such as mobile phones (including smartphones), wearable computing devices (e.g., smart watches, smart glasses, etc.) laptop computers, desktop computers, tablet computers, smart television platforms, server computers, mainframes, infotainment systems (e.g., vehicle head units), or the like.

In the example of FIG. 1, customer systems 140 may include respective software services 142A-1–142N-Z (collectively referred to herein as software services 142). Software services 142 may include computer readable instructions for a software-defined service a customer associated with customer systems 140 may offer to businesses or individuals, such as software as a service tools, software development services, cloud computing services, cybersecurity services, data analytics services, enterprise services, or the like. Software services 142, in the example of FIG. 1, may include respective machine learning (ML) model instances 152A-1–152N-Z (collectively referred to herein as “ML model instances 152”). ML model instances 152 may include computer readable instructions for executing instances of traditional machine learning models (e.g., linear regression, decision trees, support vector machines, principal component analysis, etc.) and/or instances of generative machine learning models (e.g., language models, autoencoder models, diffusion models, etc.) that may be trained to perform tasks associated with customer use cases of respective software services 142 (e.g., ML model instances 152A-1 configured to perform classification and/or generative tasks associated with service data for software service 142A-1 offered by customer system 140A). Machine learning model instances 152 may be trained to perform particular tasks for customer use cases associated with respective software services 142 based on supervised learning, unsupervised learning, reinforcement learning, or other machine learning techniques. Although illustrated as part of customer systems 140 in the example of FIG. 1, ML model instances 152 may be hosted by operations management system 110 or an external computing system with instructions for executing ML model instances 152. For example, ML model instances 152 may be executed at operations management system 110 and be configured to send and receive data to software services 142 of customer systems 140 via network 130.

Operations management system 110 may provide computer operations management services, such as a network computer. Operations management system 110 may implement various techniques for managing data operations, networking performance, customer service, customer support, resource schedules and notification policies, event management, or the like for customer systems 140. Operations management system 110 may be arranged to interface or integrate with one or more external systems such as telephony carriers, email systems, web services, or the like, to perform computer operations management. Operations management system 110 may monitor and obtain various events and/or performance metrics from customer systems 140. Operations management system 110 may determine incident response alerts (also referred to herein simply as “alerts”) based on obtained events. Operations management system 110 may be arranged to monitor factors associated with computer operations of customer systems 140 (e.g., monitor performance, compliance, or other metrics associated with machine learning models 150). For example, operations management system 110 may be arranged to monitor operational states of applications or systems of customer systems 140, network performance associated with customer systems 140, trouble tickets and/or resolutions associated with customer systems 140, or the like. Operations management system 110 may include applications with computer executable instructions that transmit, receive, or otherwise process instructions and data when executed.

Operations management system 110 may include, but is not limited to, remote computing systems, such as one or more desktop computers, laptop computers, mainframes, servers, cloud computing systems, etc. capable of sending information to and receiving information from client systems 140 via a network, such as network 130. Operations management system 110 may host (or at least provides access to) information associated with one or more applications or application services executable by client systems 140, such as operation management client application data. In some examples, operations management system 110 represents a cloud computing system that provides the application services via the cloud.

In the example of FIG. 1, operations management system 110 may include machine learning (ML) model analyzer 128, feedback signals 126, machine learning (ML) model metadata 124, use case features 132, event data 134, and machine learning models 150. Machine learning models 150 may include configuration information associated with implementing or otherwise applying various classes or categories of machine learning models to perform customer use cases associated with software services 142 of customer systems 140. For example, machine learning models 150 may include a repository of machine learning model specifications (e.g., parameter definitions, training procedures and training data inputs, fine-tuning procedures, etc.) for various classes or categories of machine learning models (e.g., Generative Pretrained Transformers, GPT, Open Pretrained Transformer, OPT, Pathway Language Model, PaLM, Language Model for Dialogue Applications, LaMDA, Enhanced Representation through Knowledge Integration, Ernie, etc.). ML model instances 152 may correspond to an execution instance of specifications for a class or category of a machine learning model stored as machine learning models 150.

Use case features 132 may include sets of one or more features defining a customer use case for a software service of software services 142. For example, use case features 132 may include features indicating tasks (e.g., classification tasks, generative tasks, etc.), output and accuracy quality values (e.g., Bilingual Evaluation Understudy, BLEU, score, Recall-Oriented Understudy for gisting Evaluation, ROUGE, score, precision criteria, F1 score, etc.), computational efficiency and performance criteria (e.g., inference latency thresholds, throughput thresholds, memory utilization thresholds, computational efficiency thresholds, etc.), user experience criteria (e.g., feedback score thresholds, feedback frequency threshold, etc.), robustness and reliability criteria (e.g., error rate thresholds), operational cost criteria (e.g., cost per inference), compliance criteria (e.g., privacy compliance standards), ethical criteria (e.g., toxicity detection), or the like.

Feedback signals 126 may include data indicating metrics associated with execution of machine learning model instances 152, such as hardware performance metrics, computational resource consumption metrics, security and compliance metrics, quantitative and/or qualitative performance metrics, event metrics associated with execution of machine learning model instances 152, alert metrics associated with execution of machine learning model instances 152, incident metrics associated with execution of machine learning model instances 152, time-to-resolve metrics associated with execution of machine learning model instances 152, or the like. Operations management system 110 may interact with a software agent of operations management system 110 executed at a customer site of customer system 140A that may be configured to collect and send data of feedback signals 126 to ML model analyzer 128 of operations management system 110.

ML model analyzer 128 of operations management system 110 may include computer-readable instructions for generating and applying ML model metadata 124. For example, ML model analyzer 128 may process feedback signals 126 to generate ML model metadata 124 by compiling or otherwise analyzing metrics of feedback signals 126 to ascertain values indicating characteristics, indicators, or other properties associated with execution of machine learning model instances 152 for customer use cases associated with respective software services 142, such as values indicating classifications or categories of industries (e.g., labels indicating industries such as medical, finance, etc.) associated with customer systems 140, values indicating one or more locations associated with customer systems 140 or software services 142, values indicating an application or outputs associated with using machine learning model instances 152, values indicating a performance of machine learning model instances 152, values indicating compliance associated with operation of machine learning model instances 152, values indicating security associated with operations of machine learning model instances 152, values indicating costs associated with operations of machine learning model instances 152, values indicating user experiences associated with operating machine learning model instances 152, or other values associated with implementations or applications of machine learning model instances 152.

ML model metadata 124 may include organized data indicating values of characteristics, indicators, or other properties that correspond metrics of feedback signals 126 to use case features 132 defining a customer use case for a software service of software services 142. ML model analyzer 128 may generate ML model metadata 124 as a table, template, index, mapping, or other data structure that maps a machine learning model of machine learning models 150 (e.g., a label for a specification of a class or category of a machine learning model within a machine learning model repository of machine learning models 150) to compiled metrics of feedback signals 126 for the machine learning model. In some examples, ML model analyzer 128 may generate an entry of ML model metadata 124 to indicate correlations between feedback signals 126 and sets of features of use case features 132 (e.g., a mapping of a machine learning model to a set of features of use case features 132 specifying machine learning mode tasks, computational constraints, service requirements, performance criteria, available data volumes). In general, ML model metadata 124 of operations management system 110 may include data indicating processed metrics of feedback signals 126 (e.g., compilations of performance data, user feedback data, computational resource consumption data, or other details of respective types of machine learning models 150, etc.).

Administrators of customer systems 140 may invest significant computational resources, time, and expenses to select, update, and otherwise maintain operations of machine learning model instances 152 to perform various customer use cases for respective software services 142. Customer systems 140 may employ vendors or internally analyze performance of various types of machine learning models (e.g., various types or vendors of large language models) trained for a particular task using iterative benchmarking techniques. Customer systems 140 may execute various types of machine learning models to perform the particular task and compare performance of the various types of machine learning models to determine which type of machine learning model to implement for the task. Additionally, or alternatively, customer systems 140 may experience incidents or issues (e.g., service disruptions) with implementing a type of machine learning model, potentially resulting in an expenditure of additional computational resources associated with improving an implemented machine learning model and/or determining a new type of machine learning model to implement. Administrators of customer system 140 may not have the data and statistics associated with identifying a cause or resolution for an incident or issue associated with performance of a machine learning model, resulting in a technical problem of not being able to diagnose and remediate the incident or issue. Operations management system 110, according to the techniques described herein, may collect feedback signals 126 as data and statistics associated with execution of various types of machine learning model instances 152. Operations management system 110 may process feedback signals 126 to generate ML model metadata 124 for machine learning model instances 152 as a dynamic data structure (e.g., template, table, mapping, index, etc.) used to select and/or diagnose implementations of machine learning model instances 152 for customer use cases associated with software services 142 offered by customer systems 140.

In accordance with the techniques described herein, operations management system 110, or more specifically ML model analyzer 128, may manage machine learning model operations for customer systems 140. ML model analyzer 128 may, for example, obtain a set of features that define a customer use case for a software service (e.g., software service 142A-1) offered by a customer system (e.g., customer system 140A) and monitored by operations management system 110. For instance, ML model analyzer 128 may obtain, via network 130, indications of a set of features defining a customer use case (e.g., classifying inputs for software services 142, generating outputs for software services 142, etc.), such as a task description, quality criteria, computational consumption and efficiency criteria, compliance and security criteria, feedback criteria, or the like. ML model analyzer 128 may obtain the set of features associated with use case features 132 via user inputs applied to a user interface output to a customer system (e.g., customer system 140A) prompting an administrator of the customer system to define features associated with use case features 132.

ML model analyzer 128 may select a machine learning model from machine learning models 150 based on a set of features associated with use case features 132. For example, ML model analyzer 128 may obtain a set of features defining a customer use case for software service 142A-1, where the set of features include one or more features of use case features 132. ML model analyzer 128 may select a machine learning model from machine learning models 150 based on one or more features of a set of features being mapped to the machine learning model in ML model metadata 124. For instance, ML model analyzer 128 may obtain, as part of a set of features for example, indications of weights or biases associated with use case features 132 mapped to labels for machine learning models of machine learning models 150 in ML model metadata 124. ML model analyzer 128 may determine a score for each machine learning model of machine learning models 150 by applying weights and biases (e.g., included in a set of features) to use case features 132 mapped to machine learning models of machine learning models 150 in ML metadata 124. ML model analyzer 128 may determine a machine learning model based on scores for machine learning models 150 (e.g., select a machine learning model from machine learning models 150 with a greater score).

ML model analyzer 128 may configure, based on selecting a machine learning model, an instance of the machine learning model to perform a customer use case for a software service offered by a customer system. For example, responsive to selecting a machine learning model from machine learning models 150 based on a set of features, ML model analyzer 128 may obtain configuration information for the machine learning model (e.g., obtain configuration information stored at machine learning models 150 associated with executing a machine learning model instance associated with a machine learning model). ML model analyzer 128 may configure an instance of a machine learning model by, for example, installing, training, updating, or otherwise executing the instance of the machine learning model based on obtained configuration information for the machine learning model. In some examples, ML model analyzer 128 may configure an instance of a machine learning model by generating a series of user interfaces to output to a customer system including instructions for an administrator to install or otherwise implement the machine learning model to perform a customer use case. ML model analyzer 128 may configure an instance of a machine learning model to perform a customer use case at operations management system 110, customer system 140, and/or an external system. For instance, in the example of FIG. 1, ML model analyzer 128 may send instructions to customer system 140A to install, train, or otherwise execute ML model instance 152A-1 for a customer use case associated with software service 142A based on ML model analyzer 128 selecting a machine learning model associated with ML model instance 152A-1.

Operations management system 110 may detect event data 134 associated software services 142. For example, operations management system 110 may include software agents deployed at a customer site of customer system 140A that are configured to detect event data 134 that includes data associated with operation of software service 142A-1, such as connection logs associated with clients connected to software service 142A-1, inputs and outputs associated with software service 142A-1, resource consumption data associated with software service 142A-1, or the like. ML model analyzer 128 may apply an instance of a machine learning model to event data 134 to determine a disruption to a software service offered by a customer system associated with the instance of the machine learning model. A disruption to a software service may include a degradation, incident, or other issue associated with operation of the software service. ML model analyzer 128 may, for example, apply ML model instance 152A-1 to event data 134 to determine a disruption to software service 142A-1 of customer system 140A by comparing outputs of ML model instance 152A-1, configured to perform a customer use case associated with software service 142A-1, to event data 134 to determine a degradation associated with service delivery latency, throughput, memory utilization, compute efficiency, etc. of software service 142A-1.

In some examples, ML model analyzer 128 may apply an instance of a machine learning model to event data 134 by configuring the instance of the machine learning model to process event data 134 to determine a disruption to a software service. For example, ML model analyzer 128 may configure ML model instance 152A-1 to predict or classify, based on event data 134, a disruption to software service 142A-1. ML model analyzer 128 may output an indication of a disruption to a software service. For example, ML model analyzer 128 may output an indication of a disruption to a software service as a notification to a customer system to alert an administrator of the customer system that a disruption to the software service may have occurred and/or may potentially occur.

In some instances, ML model analyzer 128 may process data of event data 134 associated with applying an instance of a machine learning model (e.g., data associated with inputs or outputs of ML model instance 152A-1 applied to perform a customer use case for software service 142A-1) to determine a disruption to a software service applying the instance of the machine learning model. For example, ML model analyzer 128 may process data of event data 134 associated with applying ML model instance 152A-1 to determine the data indicates that a degradation, incident, or other issue associated with software service 142A-1 has occurred potentially as a result of operations associated with ML model instance 152A-1 performing a customer use case associated with software service 142A-1. ML model analyzer 128 may classify data of event data 134 –determined to indicate a degradation, incident or other issue associated with software service 142A-1 applying ML model instance 152A-1 – as a disruption to software service 142A associated with ML model instance 152A-1. ML model analyzer 128 may output an indication of a disruption to a software service associated with an instance of a machine learning model. For example, ML model analyzer 128 may output an indication of a disruption to a software service associated with an instance of a machine learning model as a notification to a customer system to alert an administrator of the customer system that a disruption to the software service may be associated with implementation of the instance of the machine learning model.

The techniques of this disclosure include one or more advantages. For example, operations management system 110 may identify high performing machine learning models from machine learning models 150 for customer use cases associated with software services 142. Rather than manually testing various versions, vendors, classes, categories, etc. of machine learning models for a customer use case, operations management system 110 provides an automated platform for customer systems 140 to implement a selected, high performing machine learning model according to features defining the customer use case. In this way, operations management system 110 improves implementation of machine learning model instances for software services by reducing computational resources (e.g., processing usage, power consumption, memory utilization, etc.) associated with manually testing various types of machine learning models, by enhancing the identification of disruptions using efficiently trained machine learning model instances, and/or by automatically identifying and diagnosing events associated with implementation of machine learning model instances (e.g., recommendations to modify configurations associated with instance of machine learning models to increase latency, reduce errors, reduce dropped packets, etc.).

In some examples, operations management system 110 may monitor and collect feedback signals 126 associated with execution of machine learning model instances 152 to manage operations of machine learning models for customer systems 140. By providing a common platform and framework (e.g., via ML model metadata 124 and/or use case features 132) based on data collected from various customer systems 140 executing various classes or categories of machine learning model instances 152, operations management system 110 may automatically manage machine learning model implementations for customer systems 140, such as selecting and/or diagnosing machine learning model instances 152 according to features associated with computational tasks performed by machine learning model instances 152. In this way, operations management system 110 may improve implementations of machine learning models for various tasks for software services offered by customer systems 140 by, for example, reducing computational resources associated with testing various machine learning models (e.g., as a result of recommending a machine learning model based on a profile) and/or associated with diagnosing a machine learning model (e.g., as a result of identifying and/or determining violations of criteria associated with machine learning model performance, compliance, etc.).

Additionally, or alternatively operations management system 110 may recommend changes or other updates to specifications associated with machine learning model operations based on feedback signals and features associated with computational tasks performed by machine learning models executed at customer systems 140. In this way, operations management system 110 may determine specifications associated with machine learning models in a way that adapts to computational constraints, service demands, or other software service delivery system changes associated with customer systems 140.

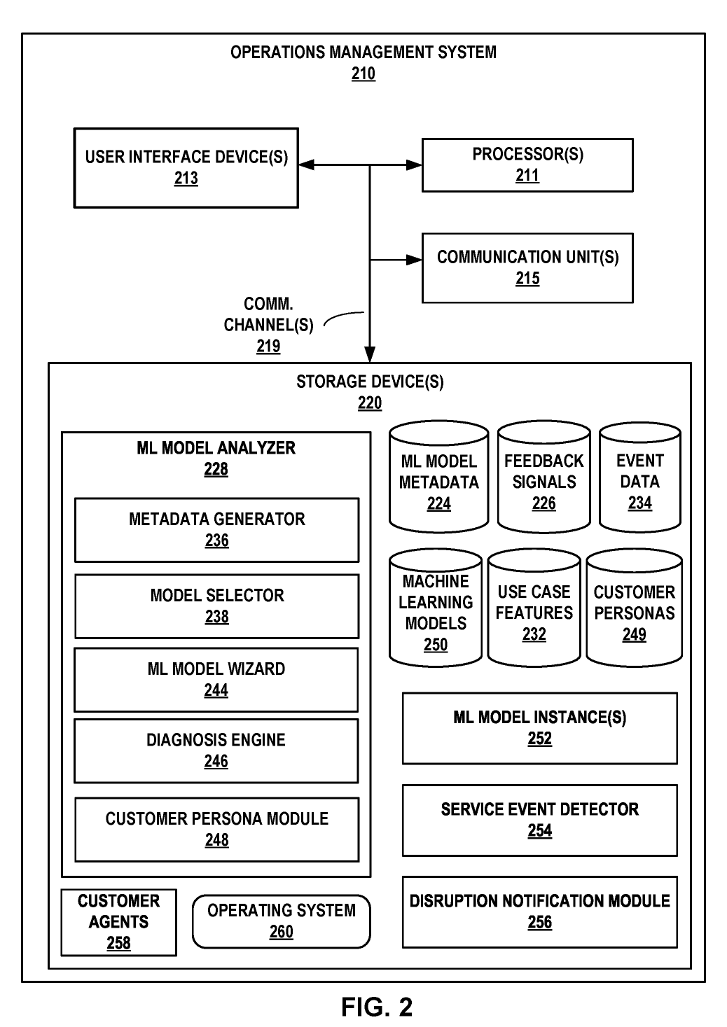

FIG. 2 is a block diagram illustrating example operations management system 210 for selecting, configuring, and otherwise managing machine learning models, in accordance with one or more techniques of this disclosure. Operations management system 210, machine learning (ML) model analyzer 228, feedback signals 226, machine learning (ML) model metadata 224, use case features 232, event data 234, machine learning models 250, and machine learning (ML) model instance 252 of FIG. 2 may be example or alternative implementations of operations management system 110, ML model analyzer 128, feedback signals 126, ML model metadata 124, use case features 132, event data 134, machine learning models 150, and ML model instance 152 of FIG. 1, respectively.

Operations management system 210, in the example of FIG. 2, may include user interface (UI) devices 213, processors 211, communication units 215, and storage devices 220. Communication channels 219 (“COMM channel(s) 219”) may interconnect each of components 213, 211, 215, and 220 for inter-component communications (physically, communicatively, and/or operatively). In some examples, communication channel 219 may include a system bus, a network connection, an inter-process communication data structure, or any other method for communicating data.

Communication units 215 may communicate with one or more external devices via one or more wired and/or wireless networks by transmitting and/or receiving network signals on the one or more networks. Examples of communication units 215 include a network interface card (e.g., such as an Ethernet card), an optical transceiver, a radio frequency transceiver, a GNSS receiver, or any other type of device that can send and/or receive information. Other examples of communication unit 215 may include short wave radios, cellular data radios (for terrestrial and/or satellite cellular networks), wireless network radios, as well as universal serial bus (USB) controllers.

UI devices 213 may be configured to function as an input device and/or an output device for operations management system 210. UI device 213 may be implemented using various technologies. For instance, UI device 213 may be configured to receive input from a user through tactile, audio, and/or video feedback. Examples of input devices include a presence-sensitive display, a presence-sensitive or touch-sensitive input device, a mouse, a keyboard, a voice responsive system, video camera, microphone or any other type of device for detecting a command from a user. In some examples, a presence-sensitive display includes a touch-sensitive or presence-sensitive input screen, such as a resistive touchscreen, a surface acoustic wave touchscreen, a capacitive touchscreen, a projective capacitance touchscreen, a pressure sensitive screen, an acoustic pulse recognition touchscreen, or another presence-sensitive technology. That is, UI device 213 may include a presence-sensitive device that may receive tactile input from a user of operations management system 210.

UI device 213 may additionally or alternatively be configured to function as an output device by providing output to a user using tactile, audio, or video stimuli. Examples of output devices include a sound card, a video graphics adapter card, or any of one or more display devices, such as a liquid crystal display (LCD), dot matrix display, light emitting diode (LED) display, miniLED, microLED, organic light-emitting diode (OLED) display, e-ink, or similar monochrome or color display capable of outputting visible information to a user of operations management system 210. Additional examples of an output device include a speaker, a haptic device, or other device that can generate intelligible output to a user. For instance, UI device 213 may present output as a graphical user interface that may be associated with functionality provided by operations management system 210.

Processors 211 may implement functionality and/or execute instructions within operations management system 210. For example, processors 211 may receive and execute instructions that provide the functionality of ML model analyzer 228, customer agents 258, operating system (OS) 260, one or more ML model instances 252 (referred to herein as “ML mode instance 252”), service event detector 254, and/or disruption notification module 256. These instructions executed by processors 211 may cause operations management system 210 to store and/or modify information within storage devices 220 or processors 211 during program execution. Processors 211 may execute instructions of ML model analyzer 228, customer agents 258, OS 260, ML model instance 252, service event detector 254, and/or disruption notification module 256. That is ML model analyzer 228, customer agents 258, OS 260, ML model instance 252, service event detector 254, and/or disruption notification module 256 may be operable by processors 211 to perform various functions described herein.

Storage devices 220 may store information for processing during operation of operations management system 210 (e.g., operations management system 210 may store data accessed by ML model analyzer 228, customer agents 258, OS 260, ML model instance 252, service event detector 254, and/or disruption notification module 256). In some examples, storage devices 220 may be a temporary memory, meaning that a primary purpose of storage devices 220 is not long-term storage. Storage devices 220 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 220 may include one or more computer-readable storage media. Storage devices 220 may be configured to store larger amounts of information than volatile memory. Storage devices 220 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 220 may store program instructions and/or information associated with ML model analyzer 228, customer agents 258, OS 260, ML model instance 252, service event detector 254, and/or disruption notification module 256.

OS 260 may control the operation of components of operations management system 210. For example, OS 260 may facilitate the communication of ML model analyzer 228, customer agents 258, ML model instance 252, service event detector 254, and/or disruption notification module 256 with processors 211, storage devices 220, and communication units 215. OS 260 may have a kernel that facilitates interactions with underlying hardware of operations management system 210 and provides a fully formed application space capable of executing a wide variety of software applications having secure partitions in which each of the software applications executes to perform various operations.

Customer agents 258 may include software programs, managed by operations management system 210, and configured to autonomously collect, monitor, process, or otherwise report metrics associated with software services offered by customer systems (e.g., software agents configured to collect feedback signals 126 associated with execution of ML model instances 152 for software services 142 of FIG. 1). Customer agents 258 may, for example, include application programming interfaces (APIs) that interact with customer systems to collect, monitor, store, or process data of feedback signals 226 to determine metrics associated with operation of instances of machine learning models configured to perform customer use cases for various software services offered by different customer systems (e.g., hardware performance metrics, computational resource consumption metrics, security and compliance metrics, quantitative and/or qualitative performance metrics, event metrics, alert metrics, incident metrics, time-to-resolve metrics, etc.). Customer agents 258 may store determined metrics as feedback signals 226 with labels indicating attributes of the feedback signals (e.g., labels indicating an industry type associated with a customer use case performed using a machine learning model instance associated with collected feedback signal data). Customer agents 258 may be configured to send ML model analyzer 228 historical and/or continuously stored feedback signals 226.

ML model analyzer 228, in the example of FIG. 2, may include metadata generator 236, model selector 238, machine learning (ML) model wizard 244, diagnosis engine 246, and customer persona module 248. Metadata generator 236 may generate ML model metadata 224 based on feedback signals 226. For example, metadata generator 236 may generate ML model metadata 224 for machine learning models of machine learning models 250 based on metrics indicated in feedback signals 226. Metadata generator 236 may cluster metrics stored at feedback signals 226 according to a label identifying classifications or categories of machine learning models of machine learning models 250. Metadata generator 236 may generate an entry of ML model metadata 224 for a classification or category of machine learning model by compiling metrics included in a cluster associated with the labeled class or category of machine learning model. For instance, metadata generator 236 may identify a cluster associated with a version or vendor of a Generative Pre-trained Transformer (GPT) model and generate an entry of ML model metadata 224 for the version or vendor of the GPT model as a vector or matrix that models metrics included in the cluster as use case feature values corresponding to features of use case features 232 (e.g., metadata generator 236 processes feedback signals 226 in a cluster to determine use case feature value of average latency, average throughput, average memory utilization, average processing efficiency for use case features of use case features 232 of latency, throughput, memory utilization, and processing efficiency, respectively).

Customer persona module 248 of ML model analyzer 228 may generate customer personas 249. Customer personas 249 may include profiles or other configuration information indicating use case feature preferences (e.g., standards, criteria, or tolerance associated with use case features 232) associated with corresponding customer systems. Customer persona module 248 may generate, update, or otherwise manage a customer persona for a customer system by, for example, processing use case feature preferences obtained from a particular customer system (e.g., use case feature preferences for multiple software services and/or customer use cases) to determine common or shared use case feature standards criteria associated with the customer system (e.g., common compliance use case feature standards, common latency use case feature criteria, etc.). In some examples, customer persona module 248 may implement machine learning techniques to classify, predict, or generate a customer persona for a customer system based on factors associated with the customer system (e.g., location factors, industry factors, computational constraint factors, feedback factors, etc.). In some instances, customer persona module 248 may create, update, or otherwise manage a customer persona of customer personas 249 according to user inputs obtained from a customer system associated with the customer persona. Customer persona module 248 may store use case feature preferences in a customer persona for a customer system by, for example, storing indications of use case features 232 with corresponding weights, biases, or other labels associated with standards (e.g., security or compliance standards), criteria (e.g., availability criteria, computational constraint criteria, performance criteria, etc.), or tolerance (e.g., risk tolerance for standards or criteria) of the customer system.

Model selector 238 of ML model analyzer 228 may select a machine learning model from machine learning models 250 based on a set of features of use case features 232. For example, model selector 238 may obtain an indication to apply a machine learning model instance for a customer use case (e.g., customer defined traditional machine learning model tasks and/or generative machine learning model tasks) for a software service (e.g., software service 142A-1 of FIG. 1) offered by a customer system (e.g., customer system 140A of FIG. 1). Model selector 238 may obtain a set of features that define the customer use case for the software service. For instance, model selector 238 may extract a set of features from use case features 232 according to use case feature preferences for a customer system indicated in a customer persona of customer personas 249 associated with the customer system (e.g., extract an industry label, location factors, performance criteria, compliance standards, security standards, etc. from use case features 232 based on a customer persona associated with a customer system). Model selector 238 may process an extracted set of features from use case features 232 by, for example, scoring each machine learning model of machine learning models 250 according to use case feature values indicated in ML model metadata 224. For instance, model selector 238 may apply weights, biases, or labels indicated in a set of features to use case feature values indicated in each entry of ML model metadata 224 to determine a score for each machine learning model category or class corresponding to entries of ML model metadata 224. Model selector 238 may select a machine learning model from machine learning models 250 based on scores for each class or category of machine learning model. For example, model selector 238 may select a particular version or vendor of machine learning model from machine learning models 250 based on a score for the version or vendor of machine learning model being greater than scores for other machine learning models of machine learning models 250.

ML model wizard 244 of ML model analyzer 228 may configure an instance of a machine learning model to perform a customer use case. For example, ML model wizard 244 may obtain, from model selector 238, an indication of a machine learning model selected from machine learning models 250. ML model wizard 244 may obtain configuration information for a selected machine learning model (e.g., specifications indicating programs, data, inputs, etc. for implementing a selected machine learning model for a customer use case obtained from data of machine learning models 250, from external sources such as the machine learning model vendor, and/or from use inputs to a user interface output by ML model wizard 244). ML model wizard 244 may configure an instance of a selected machine learning model based on obtained configuration information for the machine learning model. For example, ML model wizard 244 may configure ML model instance 252 to include instructions for applying techniques of a selected machine learning model for a customer use case associated with a set of features. ML model instance 252, in the example of FIG. 2, may include a collection of hardware and software modules configured to operate as a platform for hosting instances of machine learning models used by customer systems to perform a customer use case for a software service. ML model wizard 244 may operate as an interface between ML model instances 252 and software services offered by customer systems by, for example, communicating inputs, outputs, training data, training results, or other information between ML model instances 252 and respective software services.

In some instances, ML model wizard 244 may configure ML model instances 252 to perform corresponding customer use cases based on dynamically generated user interfaces. For example, ML model wizard 244 may include a machine learning model (e.g., a large language model) trained to generate user interfaces based on a detected step associated with a customer system implementation of a machine learning model instance to perform a customer use case for a software service. ML model wizard 244 may employ a customer agent of customer agents 258 to detect a step in a machine learning model lifecycle (e.g., steps of exploratory data analysis, data preparation, prompt engineering, fine tuning, model review and governance, model inference, model monitoring, etc.) that a customer system is currently operating in when implementing a machine learning model instance to perform a customer use case for a software service. ML model wizard 244 may generate one or more user interfaces including text, prompts, or other information specifying instructions for implementing an instance of a machine learning model according to a step of machine learning model implementation associated with a customer system and/or a set of use case features used to select the machine learning model from machine learning models 250. In general, ML model wizard 244 may dynamically output user interfaces generated according to configuration information for a selected machine learning model and/or according to use case features associated with a customer system.

Service event detector 254 may obtain event data 234, such as operations events that include alerts regarding system errors, warnings, failure reports, customer service requests, status messages, or the like. Service event detector 254 may be configured to obtain event data 234 that may be variously formatted messages that reflect the occurrence of events and/or incidents that have occurred in an organization’s computing system (e.g., client systems 140 of FIG. 1). Service event detector 254 may obtain event data 234 that may include SMS messages, HTTP requests or posts, API calls, log file entries, trouble tickets, emails, or the like. Service event detector 254 may obtain event data 234 that may be associated with one or more service teams for software services that may be responsible for resolving issues related to event data 234. In some examples, service event detector 254 may obtain event data 234 from one or more external services or agents that are configured to collect event data. Service event detector 254 may send event data 234 to diagnosis engine 246 of ML model analyzer 228.

Diagnosis engine 246 of ML model analyzer 228 may determine a disruption to a software service based at least on applying ML model instance 252 to event data 234. For example, diagnosis engine 246 may apply ML model instance 252 to event data 234 to classify or categorize data (e.g., data associated with computational operation or customer feedback for a software service, data associated with ML model instance 252 performing a customer use case for a software service, etc.) of event data 234 as a disruption (e.g., a system error, warning, failure report, customer feedback, status messages, etc.) to a software service associated with ML model instance 252 of event data 234. Diagnosis engine 246 may train ML model instance 252 to ingest event data 234 and classify particular events of event data 234 as disruptions to a software service associated with ML model instance 252. In this way, diagnosis engine 246 may apply ML model instance 252 to determine disruptions to a software service for determining whether ML model instance 252 may be a potential cause of the disruption.

In some examples, diagnosis engine 246 may determine a cause of a disruption to a software service associated with ML model instance 252. For example, diagnosis engine 246 may obtain an indication of a disruption (e.g., system error, latency drop, decrease in computational efficiency, etc.) to a software service with a timestamp associated with a time the disruption was detected or otherwise occurred. Diagnosis engine 246 may analyze event data 234 to determine times ML model instance 252 performed computational tasks or other operations associated with a customer use case for the software service. Diagnosis engine 246 may compare times ML model instance 252 performed computational tasks (e.g., stored as feedback signals 226) to timestamps associated with a disruption to determine whether operation of ML model instance 252 is a potential cause of the disruption. For instance, diagnosis engine 246 may determine ML model instance 252 is a potential cause to a disruption (e.g., decrease in computational efficiency, violation of compliance or security standards, or other deviance from an expected quality or behavior of a software service) based on a timestamp associated with the disruption corresponding to a time ML model instance 252 has been updated (e.g., to a new version, based on additional training, etc.).

In some examples, diagnosis engine 246 may generate a recommendation associated with a disruption to a software service. For example, diagnosis engine 246 may include a machine learning model (e.g., a large language model) trained to generate, based on feedback signals 226, a recommendation to resolve, alleviate, or otherwise address a disruption to a software service. For instance, diagnosis engine 246 may identify metrics of feedback signals 226 associated with a disruption (e.g., based on timestamps included in feedback signals 226). Diagnosis engine 246 may provide the identified metrics to a machine learning model trained to identify one or more portions of the identified metrics associated with the disruption. Diagnosis engine 246 may train the machine learning model generate, based on the one or more portions of the identified metrics, a recommendation indicating one or more aspects of ML model instance 252 may be a cause of the disruption and/or changes to ML model instance 252 that may resolve or otherwise address the disruption.

In some instances, diagnosis engine 246 may generate a recommendation for a disruption to a software service based on ML model metadata 224. For example, diagnosis engine 246 may determine ML model instance 252 is a potential cause of a disruption to a software service (e.g., based on a change to parameters, subsequent training, version updates, etc.). Diagnosis engine 246 may obtain a set of features defining a customer use case associated with ML model instance 252. Diagnosis engine 246 may score machine learning models of machine learning models 250 using the set of features and/or ML model metadata 224. Diagnosis engine 246 may select, based on the scoring, a machine learning model from machine learning models 250. Diagnosis engine 246 may compare the selected machine learning model to ML model instance 252 to determine whether a category or class associated with the selected machine learning model matches a category or class associated with ML model instance 252. In response to determining ML model instance 252 does not correspond to the selected machine learning model from machine learning models 250, diagnosis engine 246 may generate a recommendation indicating to change ML model instance 252 to implement software instructions associated with the selected machine learning model. In this way, diagnosis engine 246 may detect and/or prevent disruptions to software services implementing ML model instance 252 by dynamically recommending machine learning models from machine learning models 250 based on features defining a customer use case.

Disruption notification module 256 may include computer readable instructions for generating and outputting indications of disruptions. Disruption notification module 256 may, for example, prepare indication of disruptions for diagnosis engine 246 by compiling event data 234, feedback signals 226, use case features 232, customer personas 249, and/or ML model metadata 224 associated with the disruptions. In some examples, disruption notification module 256 may generate an indication of a disruption to include an indication that one or more aspects of ML model instance 252 (e.g., training data, inference latency, performance quality, incident rate, etc.) may be a cause of the disruption. In some instances, disruption notification module 256 may generate an indication of a disruption to include a recommendation, generated by diagnosis engine 246, to resolve the disruption.

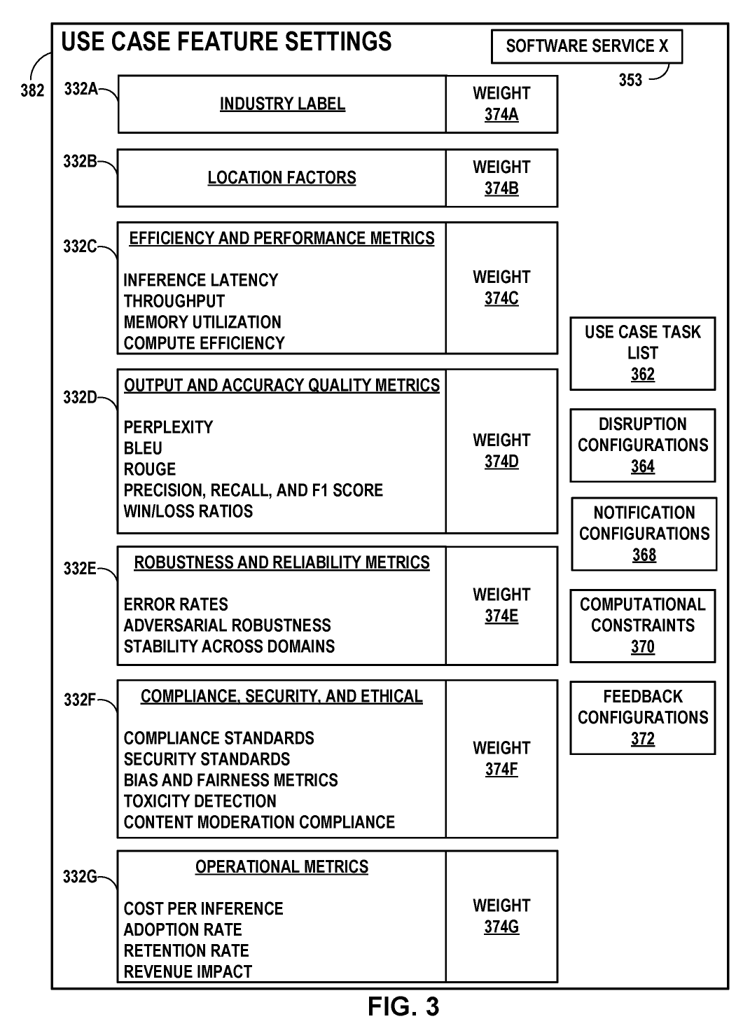

FIG. 3 is a conceptual diagram illustrating example user interface 382 for use case feature settings, in accordance with techniques of this disclosure. Use case features 332A–332G (collectively referred to as “set of use case features 332”) of FIG. 3 may be example or alternative implementations of use case features 232 of FIG. 2. FIG. 3 may be discussed with respect to FIG. 2 for example purposes only.

In the example of FIG. 3, ML model wizard 244 may generate and output user interface 382 prompting an administrator of a customer system to input values for weights 374A–374G (collectively referred to as “weights 374”) for corresponding use case features 332. Weights 374 may include a standardized value (e.g., a range of values, a classification value such as “High,” “Medium,” or “Low,” etc.) that model selector 238 may use to determine scores for selecting a machine learning model from machine learning models 250. In some instances, ML model wizard 244 may prompt, via user interface 382, an administrator of a customer system to input criteria, standards, or other parameters to further define a customer use case associated with set of use case features 332. Model selector 238 may select a machine learning model from machine learning models 250 based on set of use case features 332 (e.g., by scoring each machine learning model of machine learning models 250 using use case features 332). Additionally, or alternatively, diagnosis engine 246 may determine a disruption based on set of use case features 332 (e.g., detect a violation of efficiency and performance criteria of use case feature 332C based on obtained metrics not satisfying the performance criteria use case feature 332C by a threshold amount).

Software service label 353 may include an identifier for a software service associated with a potential and/or current implementation of ML model instance 252. Use case task list 362 may include one or more identifiers indicating classification tasks, predictive tasks, generative tasks, or other computational tasks associated with a potential and/or current implementation of ML model instance 252. Disruption configurations 364 may include configuration information for applying ML model instance 252 to event data 234. For example, disruption configurations 364 may include parameters, thresholds, or other triggering instructions that may classify data of event data 234 as a disruption, such as a risk tolerance threshold defining a disruption based on metrics of feedback signals 226 drifting away from expected values that may be defined as part of set use case features 332 (e.g., metrics of feedback signals not satisfying criteria defined in set of use case features 332 beyond a threshold amount). Notification configurations 368 may include configuration information associated with outputting notifications associated with disruptions (e.g., configuration information indicating types or content of notifications to be output in response to determining a disruption). Computational constraints 370 may include information specifying hardware or software constraints associated with a customer system (e.g., memory constraints, processing constraints, networking constraints, etc.). Feedback configurations 372 may include configuration information associated with how feedback data associated with implementation of ML model instance 252 is collected and/or otherwise communicated to operations management system 210.

In some examples, customer persona module 248 may create, update, or otherwise manage a customer persona for a customer system based on inputs associated with software service label 353, set of use case features 332, use case task list 362, disruption configurations 364, notification configurations 368, computational constraints 370, and feedback configurations 372. For example, customer persona module 248 may update a customer persona for a customer system based on information of computational constraints 370 indicating limits or thresholds associated with computational resource consumption of the customer system. Customer persona module 248 may update the customer persona by, for example, adjusting use case feature parameters of the customer persona associated with computational resource consumption.

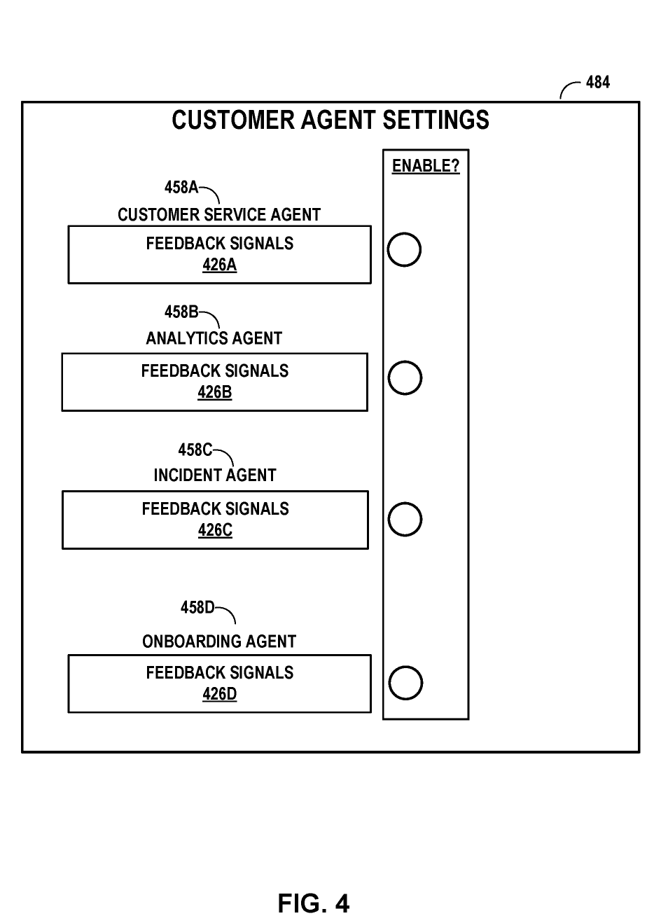

FIG. 4 is a conceptual diagram illustrating example user interface 484 for customer agent settings for collecting example feedback signals 426A–426D (collectively referred to as “feedback signals 426”), in accordance with techniques of this disclosure. Feedback signals 426 and customer agents 458A–458D (collectively referred to as “customer agents 458) of FIG. 4 may be example or alternative implementations of feedback signals 226 and customer agents 258 of FIG. 2, respectively. FIG. 4 may be discussed with respect to FIG. 2 for example purposes only.

In the example of FIG. 4, ML model wizard 244 may generate and output user interface 484 prompting an administrator of a customer system to enable customer agents 458 to collect feedback signals 426. For example, ML model wizard 244 may prompt an administrator, via user interface 484, to select whether to enable customer service agent 458A to collect feedback signals 426A indicating user experience and engagement metrics (e.g., user satisfaction score, net promoter score, engagement rate, retention rate, turn efficiency, etc.), human-agent collaboration metrics (e.g., human override rate, collaboration efficiency, etc.), or other customer service data associated with implementation of ML model instance 252. ML model wizard 244 may prompt an administrator, via user interface 484, to select whether to enable analytics agent 458B to collect feedback signals 426b indicating task completion and success metrics (e.g., task completion rate, goal achievement score, error recovery rate, first attempt success rate, etc.), accuracy and relevance metrics (e.g., intent detection accuracy, response accuracy, knowledge base utilization, precision, recall, and F1 score, etc.), behavioral metrics (e.g., response time, latency tolerance, turn-taking quality, etc.), robustness and adaptability metrics (e.g., context awareness, domain transferability, error handling efficiency, adversarial robustness), operational efficiency metrics (e.g., cost per interaction, scalability, uptime and availability, maintenance frequency, etc.), business metrics (e.g., conversion rate, revenue contribution, customer support deflection rate, customer lifetime value), or other performance-related data. ML model wizard 244 may prompt an administrator, via user interface 484, to select whether to enable incident agent 458C to collect feedback signals 426C indicating ethical, compliance, and/or security metrics (e.g., compliance data, security data, bias detection and mitigation data, toxicity rate, explainability, etc.) or other data associated with incident or disruptions of a software service associated with ML model instance 252. ML model wizard 244 may prompt an administrator, via user interface 484, to select whether to enable onboarding agent 458D to collect feedback signals 426D indicating task-specific metrics (e.g., recommendation accuracy, autonomous decision success, learning speed, step in implementation of ML model instance 252, etc.) or other data associated with an implementation process associated with ML model instance 252.

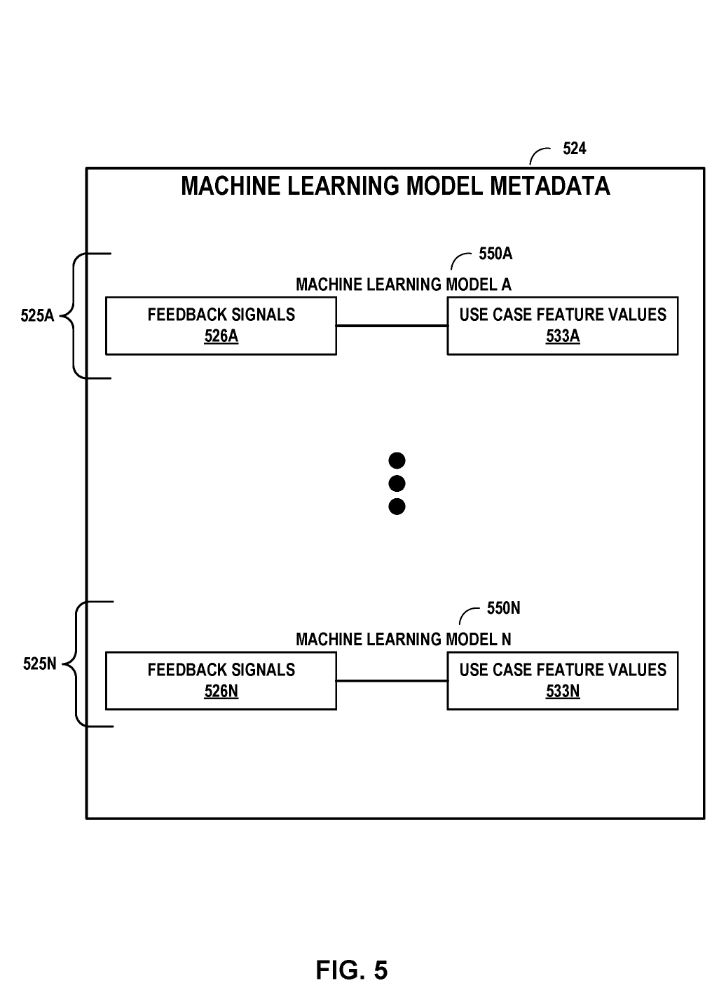

FIG. 5 is a conceptual diagram illustrating example machine learning model metadata 524, in accordance with techniques of this disclosure. Machine learning model metadata 524, machine learning models 550A–550N (collectively referred to as “machine learning models 550”), and feedback signals 526A–526N (collectively referred to as “feedback signals 526”) may be an example or alternative implementation of ML model metadata 224, machine learning models 250, and feedback signals 226 of FIG. 2, respectively. FIG. 5 may be discussed with respect to FIG. 2 for example purposes only.

Metadata generator 236 may generate machine learning model metadata 524 based at least on feedback signals 526. For example, metadata generator 236 may cluster metrics indicated in feedback signals 526 based on the metrics including labels or identifiers indicating classes, categories, versions, vendors, etc. of machine learning models of machine learning models 550. Metadata generator 236 may generate entries of metadata 525A–525N to map labels for machine learning models 550 to corresponding feedback signals 526.

In some examples, metadata generator 236 may determine use case feature values 533A–533N (collectively referred to as “feature values 533”) for respective entries of metadata 525. For example, metadata generator 236 may compile, aggregate, average, or otherwise process feedback signals 526 to determine use case feature values 533 according to use case features 232. For instance, metadata generator 236 may determine a value for use case feature values 533A associated with a performance use case feature of use case features 232 (e.g., inference latency, throughput, memory utilization, compute efficiency, etc.) by processing portions of data of feedback signals 526A associated with the performance use case feature. Metadata generator 236 may update machine learning model metadata 524 to include determine use case feature values 533.

In some instances, model selector 238 may determine a machine learning model from machine learning models 550 using machine learning model metadata 524. For example, model selector 238 may obtain a set of use case features from use case features 232 that define a customer use case for a software service. Model selector 238 may score each of machine learning models 550 based on corresponding use case feature values 533 associated with a set of use case features from use case features 232. For example, model selector 238 may score machine learning model 550A by aggregating, averaging, or otherwise processing use case feature values 533A associated with use case features in a set of obtained use case features. Model selector 238 may compare scores determined for each of machine learning models 550 to select a machine learning model from machine learning models 550.

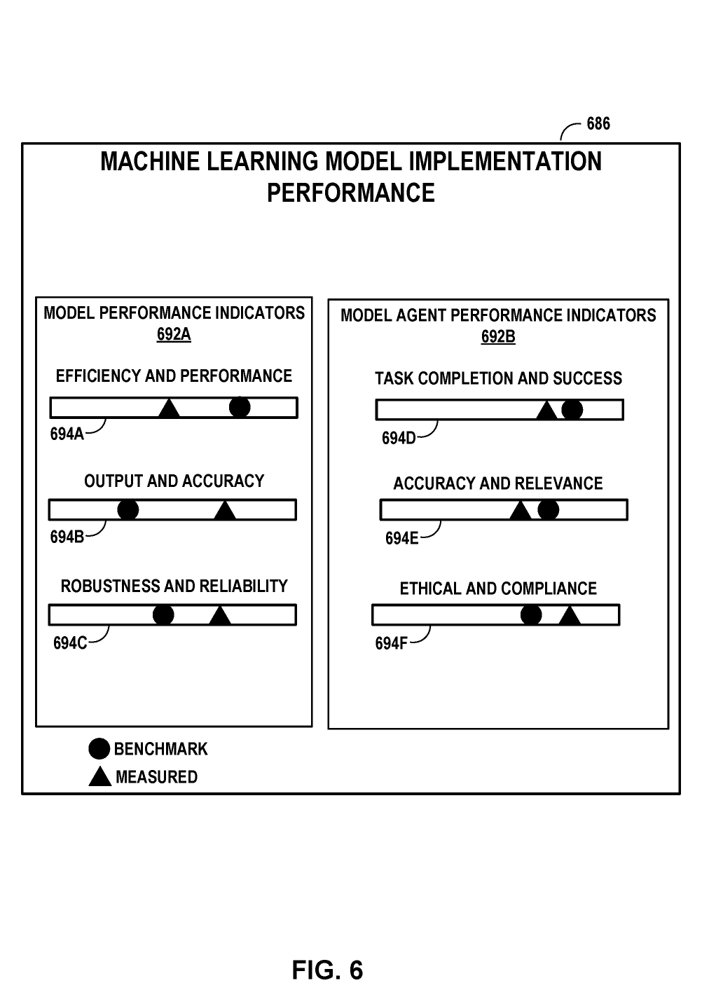

FIG. 6 is a conceptual diagram illustrating example user interface 686 indicating performance associated with a machine learning model implementation, in accordance with techniques of this disclosure. FIG. 6 may be described with respect to FIG. 2 for example purposes only.

In the example of FIG. 6, ML model wizard 244 may generate and output user interface 686 indicating machine learning model implementation performance. For example, ML model wizard 244 may obtain, from an administrator associated with a customer system, a set of benchmark performance values, such as benchmark values associated with effiency and performance of a machine learning model, output and accuracy of a machine learning model, robustness and reliability of a machine learning model, task completion and success of a machine learning model agent, accuracy and relevance of a machine learning model agent, ethical and compliance standards of a machine learning model agent, or the like. ML model wizard 244 may obtain feedback signals of feedback signals 226 indicating measured values corresponding to one or more benchmark performance values obtained from a customer system.

ML model wizard 244 may generate user interface 686 to include model performance indicators 692A and model agent performance indicators 692B with graphical elements 694A-694F that display information associated with measured performance values of a machine learning model implementation. For instance, in the example of FIG. 6, ML model wizard 244 may generate user interface 686 to include to include model performance indicators 692A and model agent performance indicators 692B with graphical elements 694A-694F as scales associated with comparisons of benchmark performance values obtained from a customer system to measured performance values (e.g., indicated in feedback signals 226) of a machine learning model implementation for the customer system. In this way, ML model wizard 244 may manage machine learning model implementation for a customer system by reporting and/or providing insight to a customer system indicating performance of a machine learning model implementation.

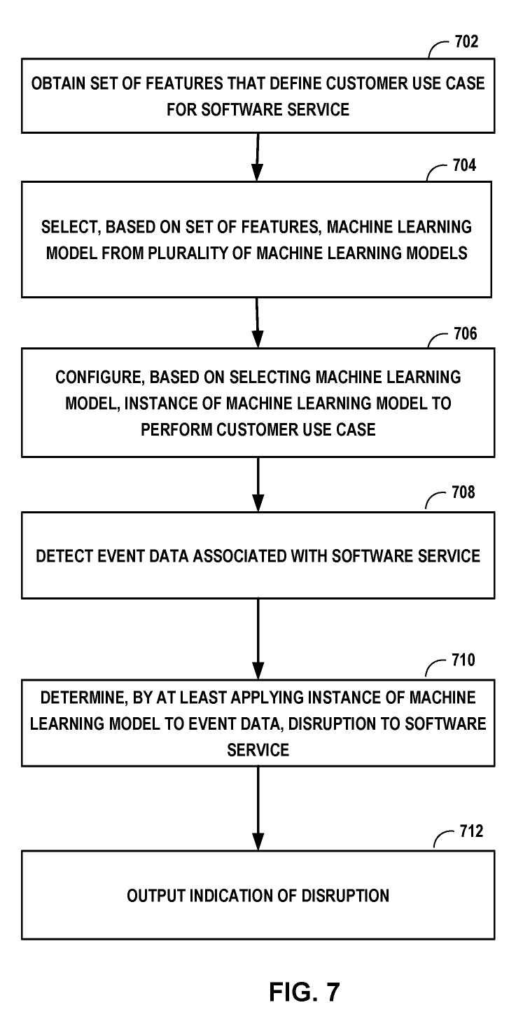

FIG. 7 is a flow chart illustrating an example process of managing machine learning models applied to customer use cases for software services, in accordance with one or more aspects of the present disclosure. FIG. 6 may be described with respect to FIG. 1 for example purposes only.

Operations management system 110 may obtain a set of features that define a customer use case for a software service (702). For example, operations management system 110 may obtain a set of features that define a customer use case for software service 142A-1 that is offered by customer system 140A and monitored by operations management system 110. Operations management system 110 may select, based on the set of features, a machine learning model from machine learning models 150 (704). Operations management system 110 may configure, based on selecting the machine learning model, an instance of the machine learning model to perform the customer use case (706). Operations management system 110 may detect event data associated with the software service (708). Operations management system 110 may determine, by at least applying the instance of the machine learning model to the event data, a disruption to the software service (710). Operations management system 110 may output an indication of the disruption (712).

Example 1: A method includes obtaining, by an operations management system and from a customer system, a set of features that define a customer use case for a software service, wherein the software service is offered by the customer system, and wherein operation of the software service is monitored by the operations management system; selecting, by the operations management system and based on the set of features, a machine learning model from a plurality of machine learning models; configuring, by the operations management system and based on selecting the machine learning model, an instance of the machine learning model to perform the customer use case; detecting, by the operations management system, event data associated with the software service; determining, by the operations management system and by at least applying the instance of the machine learning model to the event data, a disruption to the software service; and outputting, by the operations management system, an indication of the disruption.

Example 2: The method of example 1, further includes collecting, by the operations management system and responsive to configuring the instance of the machine learning model, feedback signals associated with the instance of the machine learning model, the feedback signals indicating performance data associated with applying the instance of the machine learning model to perform the customer use case, and wherein determining the disruption comprises comparing the feedback signals to one or more thresholds associated with the set of features.

Example 3: The method of any of examples 1 and 2, wherein determining the disruption to the software service comprises: determining, based on the event data, the instance of the machine learning model is a potential cause of the disruption.

Example 4: The method of any of examples 1 through 3, wherein selecting the machine learning model comprises: generating machine learning model metadata for the plurality of machine learning models based on a plurality of feedback signals indicating performance data associated with applying the plurality of machine learning models across a plurality of customer systems; determining, based on the plurality of feedback signals and a plurality of features including the set of features, feature values for each of the plurality of machine learning models; updating the machine learning model metadata to include feature values for each of the plurality of machine learning models; for each machine learning model of the plurality of machine learning models, determining a score based on the machine learning model metadata and the set of features; and selecting the machine learning model based on the score.

Example 5: The method of example 4, wherein outputting the indication of the disruption comprises: generating, based at least on the machine learning model metadata, the indication of the disruption to include a recommendation associated with addressing the disruption.

Example 6: The method of any of examples 1 through 5, wherein configuring the instance of the machine learning model to perform the customer use case comprises: obtaining configuration information associated with the machine learning model; installing the machine learning model based on the configuration information; and training the machine learning model to perform the customer use case based on the configuration information.

Example 7: The method of any of examples 1 through 6, wherein configuring the instance of the machine learning model to perform the customer use case comprises: generating one or more user interfaces including prompts associated with a step corresponding to an implementation of the instance of the machine learning model to perform the customer use case; and outputting, to the customer system, the one or more user interfaces.

Example 8: The method of any of examples 1 through 7, wherein obtaining the set of features comprises: obtaining the set of features from the customer system, wherein the set of features further include respective weights associated with features in the set of features, and wherein selecting the machine learning model comprises selecting the machine learning model further based on the respective weights.

Example 9: A system includes obtain, from a customer system, a set of features that define a customer use case for a software service, wherein the software service is offered by the customer system, and wherein operation of the software service is monitored by the operations management system; select, based on the set of features, a machine learning model from a plurality of machine learning models; configure, based on selecting the machine learning model, an instance of the machine learning model to perform the customer use case; detect event data associated with the software service; determine, by at least applying the instance of the machine learning model to the event data, a disruption to the software service; and output an indication of the disruption.

Example 10: The system of example 9, wherein the one or more processors are further configured to collect, responsive to configuring the instance of the machine learning model, feedback signals associated with the instance of the machine learning model, the feedback signals indicating performance data associated with applying the instance of the machine learning model to perform the customer use case, and wherein to determine the disruption, the one or more processors are configured to compare the feedback signals to one or more thresholds associated with the set of features.

Example 11: The system of any of examples 9 and 10, wherein to determine the disruption to the software service, the one or more processors are configured to: determine, based on the event data, the instance of the machine learning model is a potential cause of the disruption.

Example 12: The system of any of examples 9 through 11, wherein to select the machine learning model, the one or more processors are configured to: generate machine learning model metadata for the plurality of machine learning models based on a plurality of feedback signals indicating performance data associated with applying the plurality of machine learning models across a plurality of customer systems; determine, based on the plurality of feedback signals and a plurality of features including the set of features, feature values for each of the plurality of machine learning models; update the machine learning model metadata to include feature values for each of the plurality of machine learning models; for each machine learning model of the plurality of machine learning models, determine a score based on the machine learning model metadata and the set of features; and select the machine learning model based on the score.

Example 13: The system of example 12, wherein to output the indication of the disruption, the one or more processors are configured to generate, based at least on the machine learning model metadata, the indication of the disruption to include a recommendation associated with addressing the disruption.

Example 14: The system of any of examples 9 through 13, wherein to configure the instance of the machine learning model to perform the customer use case, the one or more processors are configured to: obtain configuration information associated with the machine learning model; install the machine learning model based on the configuration information; and train the machine learning model to perform the customer use case based on the configuration information.

Example 15: The system of any of examples 9 through 14, wherein to configure the instance of the machine learning model to perform the customer use case, the one or more processors are configured to: generate one or more user interfaces including prompts associated with a step corresponding to an implementation of the instance of the machine learning model to perform the customer use case; and output, to the customer system, the one or more user interfaces.

Example 16: The system of any of examples 9 through 15, wherein to obtain the set of features, the one or more processors are configured to obtain the set of features from the customer system, wherein the set of features further include respective weights associated with features in the set of features, and wherein to select the machine learning model, the one or more processors are configured to select the machine learning model further based on the respective weights.

Example 17: Computer-readable storage media encoded with instructions that, when executed, cause at least one processor of a computing system to: obtain, from a customer system, a set of features that define a customer use case for a software service, wherein the software service is offered by the customer system, and wherein operation of the software service is monitored by the operations management system; select, based on the set of features, a machine learning model from a plurality of machine learning models; configure, based on selecting the machine learning model, an instance of the machine learning model to perform the customer use case; detect event data associated with the software service; determine, by at least applying the instance of the machine learning model to the event data, a disruption to the software service; and output an indication of the disruption.

Example 18: The computer-readable storage media of example 17, wherein the instructions further cause the at least one processor of the computing system to collect, responsive to configuring the instance of the machine learning model, feedback signals associated with the instance of the machine learning model, the feedback signals indicating performance data associated with applying the instance of the machine learning model to perform the customer use case, and wherein to determine the disruption, the instructions cause the at least one processor of the computing system to compare the feedback signals to one or more thresholds associated with the set of features.

Example 19: The computer-readable storage media of any of examples 17 and 18, wherein to determine the disruption to the software service, the instructions cause the at least one processor of the computing system to determine, based on the event data, the instance of the machine learning model is a potential cause of the disruption.

Example 20: The computer-readable storage media of any of examples 17 through 19, wherein to select the machine learning model, the instructions cause the at least one processor of the computing system to: generate machine learning model metadata for the plurality of machine learning models based on a plurality of feedback signals indicating performance data associated with applying the plurality of machine learning models across a plurality of customer systems; determine, based on the plurality of feedback signals and a plurality of features including the set of features, feature values for each of the plurality of machine learning models; update the machine learning model metadata to include feature values for each of the plurality of machine learning models; for each machine learning model of the plurality of machine learning models, determine a score based on the machine learning model metadata and the set of features; and select the machine learning model based on the score.

Example 21: The computer-readable storage media of example 20, wherein to output the indication of the disruption, the instructions cause the at least one processor of the computing system to generate, based at least on the machine learning model metadata, the indication of the disruption to include a recommendation associated with addressing the disruption.

Example 22: The computer-readable storage media of any of examples 17 through 21, wherein to configure the instance of the machine learning model to perform the customer use case, the instructions cause the at least one processor of the computing system to: obtain configuration information associated with the machine learning model; install the machine learning model based on the configuration information; and train the machine learning model to perform the customer use case based on the configuration information.

Example 23: The computer-readable storage media of any of examples 17 through 22, wherein to configure the instance of the machine learning model to perform the customer use case, the instructions cause the at least one processor of the computing system to: generate one or more user interfaces including prompts associated with a step corresponding to an implementation of the instance of the machine learning model to perform the customer use case; and output, to the customer system, the one or more user interfaces.

Example 24: The computer-readable storage media of any of examples 17 through 23, wherein to obtain the set of features, the instructions cause the at least one processor of the computing system to obtain the set of features from the customer system, wherein the set of features further include respective weights associated with features in the set of features, and wherein to select the machine learning model, the instructions cause the at least one processor of the computing system to select the machine learning model further based on the respective weights.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with one or more aspects of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method comprising:
obtaining, by an operations management system and from a customer system, a set of features that define a customer use case for a software service, wherein the software service is offered by the customer system, and wherein operation of the software service is monitored by the operations management system;
selecting, by the operations management system and based on the set of features, a machine learning model from a plurality of machine learning models;
configuring, by the operations management system and based on selecting the machine learning model, an instance of the machine learning model to perform the customer use case;
detecting, by the operations management system, event data associated with the software service;
determining, by the operations management system and by at least applying the instance of the machine learning model to the event data, a disruption to the software service; and
outputting, by the operations management system, an indication of the disruption.

2. The method of claim 1, further comprising: collecting, by the operations management system and responsive to configuring the instance of the machine learning model, feedback signals associated with the instance of the machine learning model, the feedback signals indicating performance data associated with applying the instance of the machine learning model to perform the customer use case, wherein determining the disruption comprises comparing the feedback signals to one or more thresholds associated with the set of features.

3. The method of claim 1, wherein determining the disruption to the software service comprises: determining, based on the event data, the instance of the machine learning model is a potential cause of the disruption.

4. The method of claim 1, wherein selecting the machine learning model comprises:
generating machine learning model metadata for the plurality of machine learning models based on a plurality of feedback signals indicating performance data associated with applying the plurality of machine learning models across a plurality of customer systems;
determining, based on the plurality of feedback signals and a plurality of features including the set of features, feature values for each of the plurality of machine learning models;
updating the machine learning model metadata to include feature values for each of the plurality of machine learning models;
for each machine learning model of the plurality of machine learning models, determining a score based on the machine learning model metadata and the set of features; and
selecting the machine learning model based on the score.

5. The method of claim 4, wherein outputting the indication of the disruption comprises: generating, based at least on the machine learning model metadata, the indication of the disruption to include a recommendation associated with addressing the disruption.

6. The method of claim 1, wherein configuring the instance of the machine learning model to perform the customer use case comprises:
obtaining configuration information associated with the machine learning model;
installing the machine learning model based on the configuration information; and
training the machine learning model to perform the customer use case based on the configuration information.

7. The method of claim 1, wherein configuring the instance of the machine learning model to perform the customer use case comprises:
generating one or more user interfaces including prompts associated with a step corresponding to an implementation of the instance of the machine learning model to perform the customer use case; and
outputting, to the customer system, the user interface.

8. The method of claim 1, wherein obtaining the set of features comprises: obtaining the set of features from the customer system, wherein the set of features further include respective weights associated with features in the set of features, and wherein selecting the machine learning model comprises selecting the machine learning model further based on the respective weights.

9. An operations management system comprising one or more processors having access to memory, the one or more processors configured to:
obtain, from a customer system, a set of features that define a customer use case for a software service, wherein the software service is offered by the customer system, and wherein operation of the software service is monitored by the operations management system;
select, based on the set of features, a machine learning model from a plurality of machine learning models;
configure, based on selecting the machine learning model, an instance of the machine learning model to perform the customer use case;
detect event data associated with the software service;
determine, by at least applying the instance of the machine learning model to the event data, a disruption to the software service; and
output an indication of the disruption.

10. The operations management system of claim 9, wherein the one or more processors are further configured to collect, responsive to configuring the instance of the machine learning model, feedback signals associated with the instance of the machine learning model, the feedback signals indicating performance data associated with applying the instance of the machine learning model to perform the customer use case, and wherein to determine the disruption, the one or more processors are configured to compare the feedback signals to one or more thresholds associated with the set of features.

11. The system of claim 9, wherein to determine the disruption to the software service, the one or more processors are configured to: determine, based on the event data, the instance of the machine learning model is a potential cause of the disruption.

12. The operations management system of claim 9, wherein to select the machine learning model, the one or more processors are configured to:
generate machine learning model metadata for the plurality of machine learning models based on a plurality of feedback signals indicating performance data associated with applying the plurality of machine learning models across a plurality of customer systems;
determine, based on the plurality of feedback signals and a plurality of features including the set of features, feature values for each of the plurality of machine learning models;
update the machine learning model metadata to include feature values for each of the plurality of machine learning models;
for each machine learning model of the plurality of machine learning models, determine a score based on the machine learning model metadata and the set of features; and
select the machine learning model based on the score.

13. The operations management system of claim 12, wherein to output the indication of the disruption, the one or more processors are configured to generate, based at least on the machine learning model metadata, the indication of the disruption to include a recommendation associated with addressing the disruption.

14. The operations management system of claim 9, wherein to configure the instance of the machine learning model to perform the customer use case, the one or more processors are configured to:
obtain configuration information associated with the machine learning model;
install the machine learning model based on the configuration information; and
train the machine learning model to perform the customer use case based on the configuration information.

15. The operations management system of claim 9, wherein to configure the instance of the machine learning model to perform the customer use case, the one or more processors are configured to:
generate one or more user interfaces including prompts associated with a step corresponding to an implementation of the instance of the machine learning model to perform the customer use case; and
output, to the customer system, the one or more user interfaces.

16. The operations management system of claim 9, wherein to obtain the set of features, the one or more processors are configured to obtain the set of features from the customer system, wherein the set of features further include respective weights associated with features in the set of features, and wherein to select the machine learning model, the one or more processors are configured to select the machine learning model further based on the respective weights.

17. Computer-readable storage media encoded with instructions that, when executed, cause at least one processor of an operations management system to:
obtain, from a customer system, a set of features that define a customer use case for a software service, wherein the software service is offered by the customer system, and wherein operation of the software service is monitored by the operations management system;
select, based on the set of features, a machine learning model from a plurality of machine learning models;
configure, based on selecting the machine learning model, an instance of the machine learning model to perform the customer use case;
detect event data associated with the software service;
determine, by at least applying the instance of the machine learning model to the event data, a disruption to the software service; and
output an indication of the disruption.

18. The computer-readable storage media of claim 17, wherein the instructions further cause the at least one processor of the operations management system to collect, responsive to configuring the instance of the machine learning model, feedback signals associated with the instance of the machine learning model, the feedback signals indicating performance data associated with applying the instance of the machine learning model to perform the customer use case, and wherein to determine the disruption, the instructions cause the at least one processor of the operations management system to compare the feedback signals to one or more thresholds associated with the set of features.

19. The computer-readable storage media of claim 17, wherein to determine the disruption to the software service, the instructions cause the at least one processor of the operations management system to determine, based on the event data, the instance of the machine learning model is a potential cause of the disruption.

20. The computer-readable storage media of claim 17, wherein to select the machine learning model, the instructions cause the at least one processor of the operations management system to:
generate machine learning model metadata for the plurality of machine learning models based on a plurality of feedback signals indicating performance data associated with applying the plurality of machine learning models across a plurality of customer systems;
determine, based on the plurality of feedback signals and a plurality of features including the set of features, feature values for each of the plurality of machine learning models;
update the machine learning model metadata to include feature values for each of the plurality of machine learning models;
for each machine learning model of the plurality of machine learning models, determine a score based on the machine learning model metadata and the set of features; and
select the machine learning model based on the score.
